(19) United States
(12) Patent Application Publication
(10) Pub. No.: US 2010/0329200 A1
(43) Pub. Date: Dec. 30, 2010

(54) APPARATUS AND METHOD FOR ALLOCATING UPLINK RESOURCES

(75) Inventors: Ren-Jr Chen, Hsinchu City (TW); Chien-Min Lee, Xinzhuang City (TW); Hua-Lung Yang, Taipei City (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Industrial Tehnology Research Institute

(21) Appl. No.: 12/781,564

(22) Filed: May 17, 2010

Related U.S. Application Data
(60) Provisional application No. 61/219,989, filed on Jun. 24, 2009.

(51) Int. Cl. H04W 72/04

(52) U.S. Cl. 370/329

(57) ABSTRACT

An apparatus is provided for allocating uplink resources in a system in which downlink component carrier bands are aggregated and uplink component carrier bands are aggregated. The apparatus includes a processor configured to perform or cause the apparatus to perform a number of functions. The functions include receiving an assignment or an indication of an assignment of one or more resource indices to the apparatus. Additional resource indices for the apparatus may be derived as a function of an assigned resource index. The assigned resource indices and/or additional resource indices may be pre-assigned to respective pairs of downlink and uplink component carrier bands, or may be mapped to uplink component carriers. The apparatus may then be enabled to transmit or may prepare for transmission uplink control signals in an uplink component carrier band in accordance with an allocation of uplink resources specified by one of the resource indices.

### CROSS-REFERENCE TO RELATED APPLICATIONS

The present application claims priority to U.S. Provisional Patent Application No. 61/219,989, entitled: Resource Assignment for Uplink Control Channel, filed on Jun. 24, 2009, the content of which is incorporated herein by reference.

### FIELD

The present invention generally relates to allocating uplink resources, and more particularly, to allocating uplink resources in a carrier-aggregated system.

### BACKGROUND

The modern communications era has brought about a tremendous expansion of wireless networks. Various types of networking technologies have been developed resulting in unprecedented expansion of wireless computer networks, television networks, telephony networks, and the like, fueled by consumer demand. Wireless and mobile networking technologies have addressed related consumer demands, while providing more flexibility and immediacy of information transfer. However, in order to continue to meet the increasing demands of consumers for fast and reliable wireless communications, wireless networking technologies must continue to evolve. Examples of emerging technologies include the evolved universal mobile telecommunications system (UMTS) terrestrial radio access networks including UTRAN, E-UTRAN (also known as Long term Evolution—LTE), LTE advanced (LTE-A), the GERAN (GSM/EDGE) system, as well as advancements related to Worldwide Interoperability for Microwave Access (WiMAX), Wireless Municipal Access Network (WirelessMAN) or the like.

Consider a typical wireless communication system in which user equipment (UE) (or mobile stations, mobile terminals, etc.) communicate with network infrastructure including base stations (BS) (or node B or eNB elements, etc.). A UE may transmit an uplink (UL) control signal via an UL band to respond to a downlink (DL) transmission from a BS via a DL band. As currently defined by LTE-A, for example, these UL and DL bands may be up to 20 MHz. To support a higher data rate in advanced communication systems, however, a wider transmission bandwidth is required. In practice, it is difficult to derive a contiguous band having the desired bandwidth (e.g., 100 MHz) for many situations. In an effort to address this issue, a so-called carrier aggregation technique has been proposed in which multiple bands—each of which may be referred to as a component carrier (CC), may be contiguously or discontiguously aggregated to meet a particular increased system requirement for DL/UL bandwidth. Thus, for example, five 20 MHz component carriers may be aggregated to achieve an effective DL/UL bandwidth of 100 MHz.

In many instances, DL transmissions have a higher data rate than UL transmissions, which in those instances, may imply that the DL has a wider bandwidth and may benefit from aggregation of more CCs than the UL. In the UL in which fewer CCs may be aggregated, then, the UE may be reconfigured to turn off unnecessary or undesired UL CCs when the UE has no need to upload data. Thus, when a communication system implements unequal numbers of DL/UL CCs, a UE may simultaneously transmit multiple UL control signals (or report channel state information) via a single UL CC to respond to DL transmissions via multiple DL CCs.

### SUMMARY

In light of the foregoing background, exemplary embodiments of the present invention provide improved apparatuses, methods and computer-readable storage mediums for allocating uplink resources (“exemplary” as used herein referring to “serving as an example, instance or illustration”). According to one aspect of exemplary embodiments of the present invention, an apparatus is provided for allocating uplink resources in a system in which a plurality of downlink component carrier bands are aggregated and a plurality of uplink component carrier bands are aggregated, and in which the apparatus is configured to transmit an uplink control signal in one of the uplink component carrier bands in response to a downlink transmission in one of the downlink component carrier bands. The apparatus includes a processor configured to perform or cause the apparatus to perform a number of functions. As recited, the functions include receiving an assignment or an indication of an assignment of a resource index to the apparatus, and deriving one or more additional resource indices for the apparatus as a function of the assigned resource index. Each of the assigned resource index and additional resource indices specify an allocation of uplink resources for the apparatus to transmit uplink control signals. Also, the assigned resource index and additional resource indices may be static, or one or more of the assigned resource index or one or more of the additional resource indices may vary over time in accordance with a hopping function.

The functions according to this aspect also include mapping the assigned and additional resource indices to a subset of uplink component carrier bands, where the subset includes one or more of the plurality of uplink component carrier bands. For each uplink component carrier band in the subset, mapping the assigned and additional resource indices to the uplink component carrier band enables the apparatus to transmit one or more uplink control signals in the uplink component carrier band in accordance with the allocation of uplink resources specified by the respective assigned and additional resource indices.

The resource indices may be mapped in a number of different manners. For example, the assigned and additional resource indices may be sequentially mapped to the uplink component carrier bands of the subset, and employing a module operation to map any remaining resource indices when the number of assigned and additional resource indices exceeds the number of uplink component carrier bands in the subset. As another example, the assigned and additional resource indices may be mapped to the uplink component carrier bands of the subset according to a setting of a number of uplink control signals the apparatus is permitted to transmit in an uplink control carrier band of the subset. In this example, the setting may be such that a different number of resource indices are mapped to at least one component carrier band than are mapped to at least one other component carrier band of the subset.

According to another aspect of exemplary embodiments of the present invention, an apparatus is provided for allocating uplink resources in a system similar to that described above. Additionally, the apparatus similarly includes a processor configured to perform or cause the apparatus to perform a number of functions. As per this other aspect of exemplary embodiments of the present invention, however, the functions include receiving an assignment or an indication of an assignment of a plurality of resource indices to the apparatus, which may be static or one or more of which may vary over time in accordance with a hopping function.

The assigned resource indices are pre-assigned to respective pairs of component carrier bands each of which includes a downlink component carrier band and an uplink component carrier band. The functions of this aspect also include identifying a resource index from the assigned resource indices, where the respective resource index is identified as being pre-assigned to a particular pair of component carrier bands including a downlink component carrier band in which a downlink transmission is received. Additionally, the functions include preparing for transmission an uplink control signal in accordance with the allocation of uplink resources specified by the identified resource index, and prepared for transmission in the uplink component carrier of the particular pair of component carrier bands.

The assigned resource indices may be from a greater plurality of available resource indices pre-assigned to respective pairs of component carrier bands, which may be reflected in a table stored by the user equipment. In such instances, the resource index may be identified from the table, and preparing an uplink control signal may include identifying from the table the uplink component carrier of the particular pair of component carrier bands.

The plurality of downlink component carrier bands and uplink component carrier bands may be organized in groups each of which includes one or more downlink component carrier bands and one or more uplink component carrier bands. Each of the available resource indices may be pre-assigned to each of one or more of the groups. For each group, the respective pre-assigned available resource indices may be further pre-assigned to respective pairs of the component carrier bands of the group. The processor, then, may be further configured to perform or cause the apparatus to receive an assignment or an indication of an assignment of one of the groups to the apparatus; and the resource index may be identified further from the assigned group.

The pre-assigned resource indices may be further pre-assigned to respective pairs of the component carrier bands in a number of different manners. In a localized manner, for example, the pre-assigned resource indices may be further assigned such that ranges of consecutive ones of the respective pre-assigned resource indices are assigned to respective pairs of the component carrier bands. And in a distributed manner, for example, the pre-assigned resource indices may be further assigned such that the respective pre-assigned resource indices are sequentially assigned to respective pairs of the component carrier bands.

In either of the aforementioned aspects of exemplary embodiments of the present invention, the processor may be further configured to perform or cause the apparatus to prepare for transmission a single uplink control signal in one of the uplink component carrier bands in response to downlink transmissions in two or more of the downlink component carrier bands. In these instances, the single uplink control signal may separately reflect an acknowledgement (ACK) or negative acknowledgement (NACK), or a discontinuous transmission (DTX), for each of the downlink transmissions.

As indicated above and explained below, exemplary embodiments of the present invention may solve problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram illustrating components of an exemplary system, in accordance with exemplary embodiments of the present invention;

FIG. 2 is a schematic block diagram of an apparatus configured to operate as a base station or user equipment, in accordance with exemplary embodiments of the present invention;

FIG. 3 is a schematic block diagram illustrating an example of the aggregation of multiple component carriers, in accordance with exemplary embodiments of the present invention;

FIG. 4 is a schematic block diagram illustrating an example of user equipment UE(s) transmitting uplink (UL) control signals, in accordance with exemplary embodiments of the present invention;

FIG. 5 is a table illustrating UEs mapping resource indices to UL component carriers, in accordance with a first exemplary embodiment of the present invention;

FIGS. 6a, 6b and 6c are tables by which resource indices may be pre-assigned to different pairs of downlink (DL) and UL component carriers, in accordance with a second exemplary embodiment of the present invention;

FIGS. 7a and 7b are schematic block diagrams illustrating assigning resource indices to UEs for the transmission of arranged and non-arranged control signals, in accordance with the second exemplary embodiment of the present invention;

FIG. 8 is a schematic block diagram illustrating the organization of DL and UL component carriers in UE-specific or cell-specific DL/UL CC groups, in accordance with a third exemplary embodiment of the present invention;

FIGS. 9 and 10 are tables respectively illustrating localized and distributed manners of assigning resource indices to each pair of DL and UL CCs in each DL/UL CC group, in accordance with the third exemplary embodiment of the present invention;

FIG. 11 is a schematic block diagram illustrating an example organization of DL/UL CC groups, in accordance with the third exemplary embodiment of the present invention; and

FIG. 12 is a schematic block diagram illustrating an example organization of DL/UL CC groups in the context of transmitting acknowledgement (ACK) or negative acknowledgement (NACK) control signals in which multiple signals may be transmitted together, in accordance with the exemplary embodiments of the present invention.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

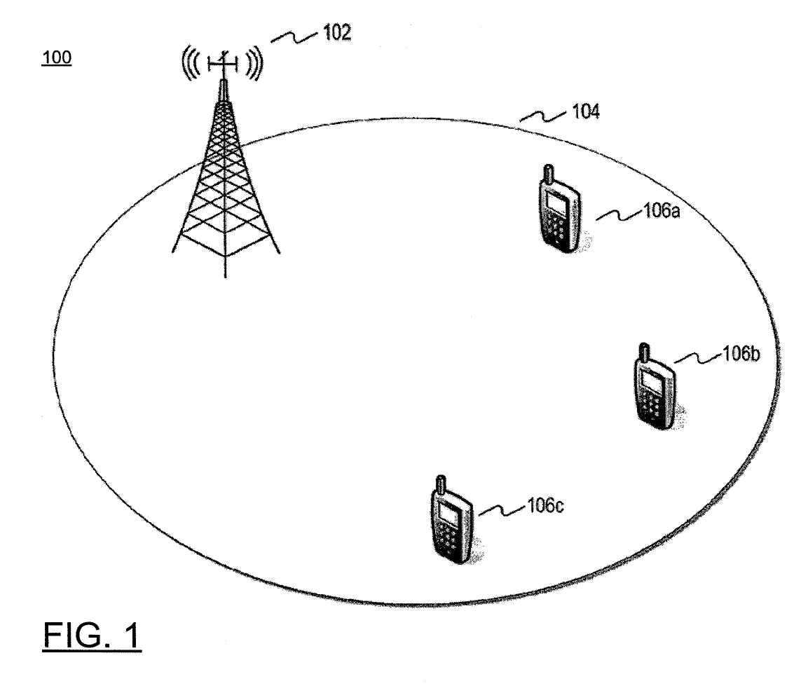

FIG. 1 is a schematic block diagram illustrating components of an exemplary system 100 for implementing exemplary embodiments. The system may include one or more wireless communications networks. Examples of such networks include 3GPP radio access networks, Universal Mobile Telephone System (UMTS) radio access UTRAN (Universal Terrestrial Radio Access Network), Global System for Mobile Communications (GSM) radio access networks, Code Division Multiple Access (CDMA) 2000 radio access networks, Wireless Local Area Networks (WPANs) such as IEEE 802.xx networks (e.g., 802.11a, 802.11b, 802.11g, 802.11n, etc.), world interoperability for microwave access (WiMAX) networks, IEEE 802.16, and/or wireless Personal Area Networks (WPANs) such as IEEE 802.15, Bluetooth, low power versions of Bluetooth, infrared (IrDA), ultra wideband (UWB), Wibree, Zigbee or the like. 3GPP radio access networks may include, for example, 3G (e.g., GERAN) or 3.9G (e.g., UTRAN Long Term Evolution (LTE) or Super 3G) or E-UTRAN (Evolved UTRAN) networks.

As shown, the network(s) may include one or more infrastructure components such as base stations (BSs) 102. The BS may be configured to communicate with one or more equipment (UE) 106 (or mobile stations, mobile terminals, etc.) to transmit and receive voice and data information via the network(s)—three example UEs being shown as UE 106a, 106b and 106c. Although a specific numbers of BSs and UEs are shown, FIG. 1 is exemplary and any numbers of BSs and mobile devices may be provided. Furthermore, the functions provided by one or more devices of system 100 may be combined, substituted, or re-allocated among various devices.

The BS 102 may include any appropriate apparatus or system that facilitates communication between a UE and a network. For example, in some embodiments, the BS may include a wireless communication device installed at a fixed location to create a cell 104 or defined geographic region of network coverage, such as a node B or eNB, a base transceiver system (BTS), an access point, a home BS, etc. In other example embodiments, the BS may be a relay station, an intermediate node, or an intermediary. The BS may include any appropriate type of wireless or radio BS, such as a land-based communication BS or a satellite-based communication BS. The BS may include any appropriate type voice, data, and/or integrated voice and data communication equipment to provide high speed data and/or voice communications. In other example embodiments, any other type of BS or equivalent thereof may be used.

The UEs 106 may be any type of device for communicating with a BS 102. For example, a UE may be a mobile communication device, or any other appropriate computing platform or device capable of exchanging data and/or voice information with BS such as servers, clients, desktop computers, laptop computers, network computers, workstations, personal digital assistants (PDA), tablet PCs, scanners, telephony devices, pagers, cameras, musical devices, etc. A UE may be a fixed computing device operating in a mobile environment, such as, for example, a bus, a train, an airplane, a boat, a car, etc. In some embodiments, a UE may be configured to communicate with the BS using any of the various communication standards supporting mobile communication devices. The UEs may be configured to communicate with other UEs (not shown) directly or indirectly via BS or other BSs or computing systems (not shown) using wired or wireless communication methods.

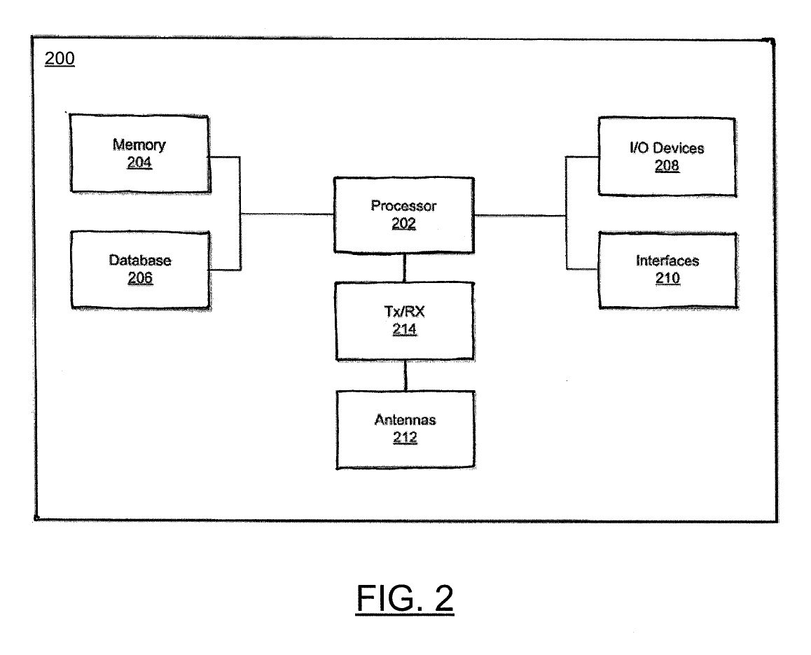

FIG. 2 illustrates a block diagram of an apparatus 200 that may be configured to operate as a BS 102 or UE 106, in accordance with exemplary embodiments. As shown in FIG. 2, apparatus may include one or more of the following components: at least one processor 202 configured to execute computer readable instructions to perform various processes and methods, memory 204 configured to access and store information and computer readable instructions, database 206 to store tables, lists, or other data structures, I/O devices 208, interfaces 210, antennas 212 and transceivers 214.

The processor 202 may include a general purpose processor, application specific integrated circuit (ASIC), embedded processor, field programmable gate array (FPGA), microcontroller, or other like device. The Processor may be configured to act upon instructions and data to process data output from transceiver 214, I/O devices 208, interfaces 210 or other components that are coupled to processor. In some exemplary embodiments, the processor may be configured to exchange data or commands with the memory 204. For example, the processor may be configured to receive computer readable instructions from the memory and perform one or more functions under direction of the respective instructions.

The memory 204 may include a volatile or non-volatile computer-readable storage medium configured to store data as well as software, such as in the form of computer readable instructions. More particularly, for example, the memory may include volatile or non-volatile semiconductor memory devices, magnetic storage, optical storage or the like. The memory may be distributed. That is, portions of the memory may be removable or non-removable. In this regard, other examples of suitable memory include Compact Flash cards (CF cards), Secure Digital cards (SD cards), Multi-Media cards (MMC cards) or Memory Stick cards (MS cards) or the like. In some exemplary embodiments, the memory may be implemented in a network (not shown) configured to communicate with the apparatus 200.

The database 206 may include a structured collection of tables, lists or other data structures. For example, the database may be a database management system (DBMS), a relational database management system, an object-oriented database management system or similar database system. As such, the structure may be organized as a relational database or an object-oriented database. In other exemplary embodiments, the database may be a hardware system including physical computer-readable storage media and input and/or output devices configured to receive and provide access to tables, lists, or other data structures. Further, hardware system database may include one or more processors and/or displays.

The I/O devices 208 include any one or more of a mouse, stylus, keyboard, audio input/output device, imaging device, printing device, display device, sensor, wireless transceiver or other similar device. The I/O devices may also include devices that provide data and instructions to the memory 204 and/or processor 202.

The interfaces 210 may include external interface ports, such as USB, Ethernet, FireWire®, and wireless communication protocols. The interfaces may also include a graphical user interface, or other humanly perceivable interfaces configured to present data, including but not limited to, a portable media device, traditional mobile phone, smart phone, navigation device, or other computing device. The apparatus 200 may be operatively connected to a network (not shown) via a wired and/or wireless communications link using the interface.

The transceiver 214 may include any appropriate type of transmitter and receiver to transmit and receive voice and/or data from other apparatuses (e.g., BS 102, UE 106). In some exemplary embodiments, the transceiver may include one or a combination of desired functional component(s) and processor(s) to encode/decode, modulate/demodulate and/or perform other wireless communication-channel-related functions. The transceiver may be configured to communicate with an antenna 212 (e.g., single antenna or antenna array) to transmit and receive voice and/or data in one of various transmission modes.

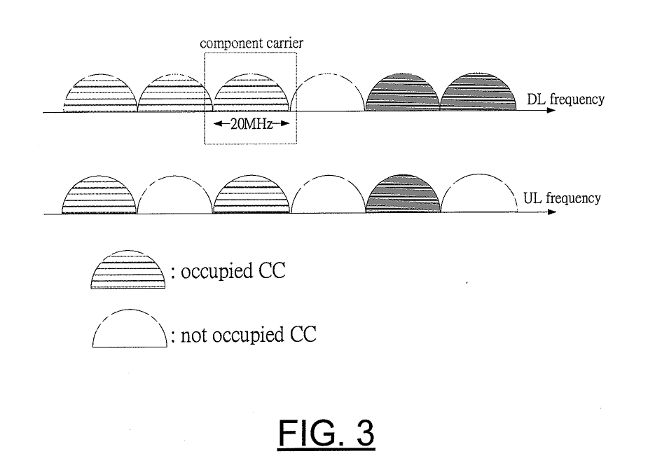

As explained in the background section, a UE may transmit an uplink (UL) control signal via an UL band to respond to a downlink (DL) transmission from a BS via a DL band. These control signals may include, for example, a channel quality indicator (CQI), an acknowledgement (ACK), negative acknowledgement (NACK) or the like. These ACK/NACK control signals may be configured according to any of a number of different error control techniques, such as the hybrid automatic repeat request (HARQ) technique. To support a higher data rate in advanced communication systems, multiple component carrier (CC) bands may be aggregated to meet a particular increased system requirement for DL/UL bandwidth. Thus, for example, five 20 MHz component carriers may be aggregated to achieve an effective DL/UL bandwidth of 100 MHz. An example of the aggregation of multiple CCs is shown in FIG. 3.

As also shown in FIG. 3, in many instances, DL transmissions have a higher data rate than UL transmissions, which in those instances, may imply that the DL has a wider bandwidth and may benefit from aggregation of more CCs than the UL. In the UL in which fewer CCs may be aggregated, then, the UE may be reconfigured to turn off unnecessary or undesired UL CCs when the UE has no need to upload data. Thus, when a communication system implements unequal numbers of DL/UL CCs, a UE may simultaneously transmit multiple UL control signals (or report channel state information) via a single UL CC to respond to DL transmissions via multiple DL CCs.

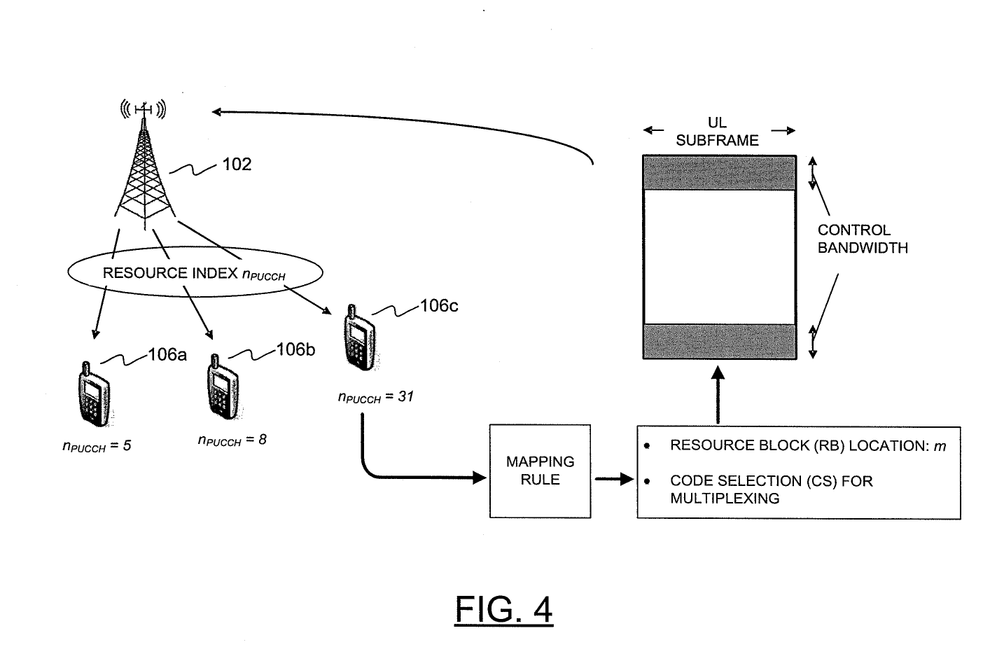

In a wireless communication system such as LTE, a BS may allocate UL resources to UEs served by the BS. For each UE, its allocated resources may be reflected by a UE-specific resource index. In this regard, the UE may map to a resource block (RB) location m in an UL subframe on the UL—a physical uplink control channel (PUCCH) in the context of LTE. And as control signals from multiple UEs may be multiplexed within a single RB, the resource index may be mapped to a multiplexing code (cyclic shift of a particular sequence—CS) and an orthogonal cover (OC), if necessary. This is shown, for example, in FIG. 4.

Exemplary embodiments of the present invention provide an apparatus, method and computer-readable storage medium for allocating uplink resources to user equipment. According to one exemplary embodiment, to avoid the BS 102 using extra overhead to signal multiple resource indices for a UE 106, each UE may be assigned a single resource index without regard to a number of UL control signals the UE may simultaneously transmit. Each UE, then, may derive other resource indices from its respectively assigned resource index. After a UE is assigned or otherwise derives its resource indices, the UE may accordingly arrange its UL control signals over UL CCs according to a predefined rule, and calculate corresponding RB locations and determine corresponding code (CS and/or OC) selections based upon the respective resource indices.

According to a second exemplary embodiment, each UL control signal from each UE 106 may be assigned a resource index. That is, a UE may be assigned multiple resource indices at one time. For each UE, the resource indices may be assumed to be pre-assigned to different pairs of DL and UL CCs. Also for each UE, the BS 102 and UE may both maintain the same knowledge on how the resource indices have been assigned to CCs, such as by using the same table or tables. In this regard, an assigned resource index may inform a UE which UL CC should be selected to transmit a control signal when a DL transmission is received from a particular DL CC. The system may therefore experience increased flexibility to arrange or schedule the UL control signals of the UEs. This increased flexibility may permit the system to realize benefits such as balanced UL CC loading and balanced physical uplink control information (PUCCH) performance, randomized multiple access interference on PUCCH, power saving and the like.

According to a third exemplary embodiment, DL and UL CCs may be organized in groups, which may be UE-specific or cell-specific. Generally, each UL control signal may be sent in an UL CC of a DL/UL group responsive to the DL transmission from a DL CC of the same group. To realize power savings, the UL control information may be transmitted at the same time such as by employing a bundling- or multiplexing-based method.

According to the aforementioned three exemplary embodiments, the UEs 106 may be assigned one or more resource indices n_{PUCCH} in any of a number of different manners. As described herein, these and other assignments may be made by the BS 102 serving the UE. It should be understood, however, one or more assignments described herein may be alternatively made by another network infrastructure component implementing the same or higher-layer functionality than the BS, such as a radio network controller (RNC) implementing radio resource control (RRC) functionality. Regardless of the particular assigning-component, the respective component may transmit an indication of the assignment to the respective UE, as appropriate.

Relative to resource indices, for example, the assigning-component may communicate an indication of the assigned resource index/indices to the UE 106 (e.g., BS 102 to UE, or RNC—via BS—to UE). More particularly, for example, the assigning-component may communicate actual assigned resource index/indices to the UE. Alternatively, for example, the assigning-component may communicate resource index-related information to the UE. In these instances, the UE may calculate the actual assigned resource index/indices based on the resource index-related information, alone or further based on additional similar information—such as information received by the UE on a DL control channel. As one example, see 3GPP TS 36.213, which describes calculation of an actual assigned resource index as the combination of a control channel element index (n_{CCE}) and higher-layer-configured resource index-related information (N_{PUCCH}).

Each of the aforementioned three exemplary embodiments will now be described in greater detail. It should be understood that the BS 102 and any UE 106 may be configured to operate according to any one or more of the exemplary embodiments. Thus, for example, the BS and all of its served UEs may operate according to one of the exemplary embodiments. Alternatively, for example, the BS may be configured to operate according to multiple ones of the exemplary embodiments, with various ones of the served UEs being configured to operate according to different ones of the exemplary embodiments (e.g., some UEs being configured to operate according to the first exemplary embodiment, while others of the UEs are configured to operate according to the second exemplary embodiment).

More particularly with reference to the first exemplary embodiment, each UE 106 may be assigned a single resource index, regardless of how many UL control signals the UE may transmit at any given time or period of time. Each UE, then, may derive other resource indices from its respectively assigned resource index, such as in accordance with a predefined function and a cell-specific or UE-specific parameter. In various instances, this parameter may be predetermined or otherwise set by the BS or higher-layer functionality (e.g., RNC implementing RRC functionality), which may transmit an indication of the parameter to the UE.

Also in accordance with the first exemplary embodiment, consider that the BS 102 (or higher-layer functionality) may assign a subset of UL CCs to each UE 106 for the transmission of UL control signals, and the BS may transmit an indication of the respective subset to the UE. Additionally, the BS (or higher-layer functionality) may set the number of UL control signals that may be transmitted in an UL CC of the subset, an indication of which may be transmitted by the BS along with an indication of the subset to each UE.

After a UE 102 receives an indication of the assigned resource index and derives other resource indices, and receives an indication of a subset of UL CCs, the UE may map its resource indices over the subset of UL CCs according to a predefined mapping rule such that each UE may include one or more resource indices mapped to each of one or more UL CCs. For each resource index in each UL CC, then, the UE may calculate the corresponding RB location and determine the corresponding code (CS and/or OC) selection based on the resource index, and transmit a control signal in the UL CC according to the respective RB location and code selection. This may be accomplished, for example, in accordance with the LTE specification as reflected in 3GPP TS 36.211.

Different UEs 102 may be assigned the same resource index and may include some of the same UL CCs in their respective subsets, and a UE may map one or more resource indices to any UL CC. The resource indices may be assigned and derived, the subset of UL CCs may be assigned, and/or the predefined mapping rule may be configured such that the resource index or indices of each UE within a particular UL CC is/are unique to the respective UE—thereby avoiding collisions between the indices of different UEs within the same UL CC. According to one example, the predefined mapping rule may specify that each UL sequentially map its resource indices to UL CCs in its subset beginning with the largest/smallest resource index and corresponding largest/smallest index of UL CC. And in instances in which the number of resource indices is greater than the number of UL CCs in the subset, the UE may employ a module operation to map the remaining resource indices after a resource index has been mapped to each UL CC in the subset.

A method for deriving resource indices and mapping the resource indices over subsets of UL CCs according to exemplary embodiments of the present invention may be more notationally represented for a UE-k and five available UL CCs in accordance with LTE as follows:

```
Let
  assigned resource index = n_{PUCCH};
  UE-specific parameter = Δₖ; and
  assigned subset of UE-specific UL CCs, S = {s(0), s(1), ..., s(ε − 1)},
    ε ≦ 5 and s(ε) represents the index of the UL CCs
then,
  assigned and derived resource indices = {n_{PUCCH}, (n_{PUCCH} + Δₖ),
    (n_{PUCCH} + 2Δₖ), ..., (n_{PUCCH} + (I − 1)Δₖ)}, ε ≦ I ≦ 5;
  for i = 0:1:I − 1
    assigned and derived resource indices: (n_{PUCCH} + iΔₖ)
    mapped UL CC: s(i mod ε)
    resource index used in UL CC: (n_{PUCCH} + iΔₖ) mod (B in s(i mod
      ε)), where B represents the maximum allowable resource
      index given the bandwidth of the PUCCH format 1 or 2
  end
```

To further illustrate this first exemplary embodiment, consider an example scenario in which a BS 102 assigns resource indices n_{PUCCH}=25, 26, 21, 22, 23, 22 to respective ones of a number of UEs 106 designated UE-1, K, 2, 3, 4, 5; and may set UE-specific parameters Δₖ for the respective UEs (the subscript k reflecting a particular UE-k) as follows: {1, 1, 2, 2, 1, 1}. The UEs may therefore derive other resource indices from their respectively assigned resource indices, such as follows:
UE-1: {25, 25+Δ₁, 25+2Δ₁, 25+3Δ₁, 25+4Δ₁}={25, 26, 27, 28, 29}
UE-K: {26, 26+Δ_{K}, 26+2Δ_{K}, 26+3Δ_{K}, 26+4Δ_{K}}={26, 27, 28, 29, 30}
UE-2: {21, 21+Δ₂, 21+2Δ₂, 21+3Δ₂, 21+4Δ₂}={21, 23, 25, 27, 29}
UE-3: {22, 22+Δ₃, 22+2Δ₃, 22+3Δ₃, 22+4Δ₃}={22, 24, 26, 28, 30}
UE-4: {23, 23+Δ₄, 23+2Δ₄, 23+3Δ₄, 23+4Δ₄}={23, 24, 25, 26, 27}
UE-5: {22, 22+Δ₅, 22+2Δ₅, 22+3Δ₅, 22+4Δ₅}={22, 23, 24, 25, 26}

Also per the above example scenario, the BS 102 may assign subsets of UL CCs {0, 1, 2}, {0, 1, 2, 4}, {0, 1, 2, 4}, {0, 1, 2, 4, 5}, {0, 2, 4, 5}, {4, 5} to respective ones of UE-1, K, 2, 3, 4, 5.

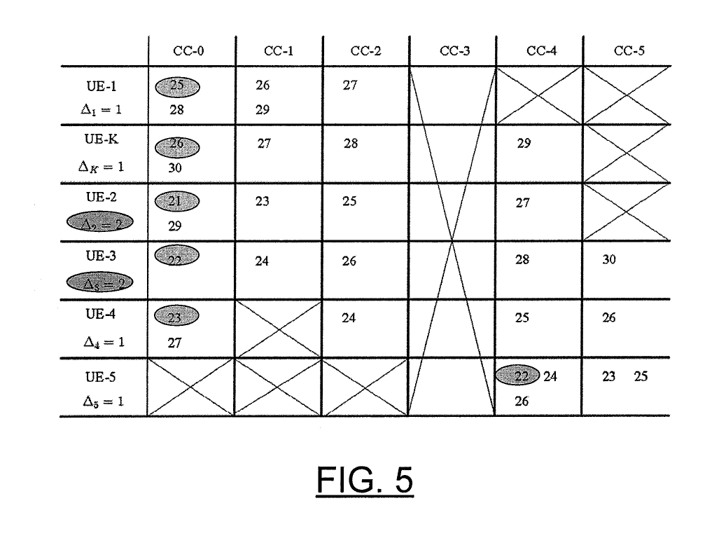

Each UE 106 may map its resource indices over its subset of UL CCs, such as by sequentially assigning the resource indices to UL CCs, and applying a module operation when the number of resource indices is greater than the number of UL CCs. For example, UE-1 may sequentially and respectively assign resource indices {25, 26, 27} to UL CCs {0, 1, 2}, and then assign the remaining resource indices {28, 29} to UL CCs {0, 1} according to the module operation. The resource indices mapped to UL CCs according to the above example scenario are illustrated in FIG. 5. Again, for each resource index in each UL CC, the UE 106 may calculate the corresponding RB location and determine the corresponding code (CS and/or OC) selection based on the resource index, and transmit a control signal in the UL CC according to the respective RB location and code selection.

In the example shown in FIG. 5, the UEs 106 may sequentially map its resource indices to UL CCs beginning with the largest/smallest resource index and corresponding largest/smallest UL CC. Thus, for UE-1 with five resource indices and a subset of three UL CCs {0, 1, 2}, the resource indices may be mapped to the UL CCs such that CC-0 and CC-1 include two resource indices, and CC-2 includes one resource index—the UL CCs to which the resource indices are mapped being designated {0, 0, 1, 1, 2}. As indicated above, however, the BS 102 may set the number of UL control signals that may be transmitted in an UL CC of the subset. In these instances, the BS may set the UL control signals such that fewer or more resource indices are mapped to one or more UL CCs. For example, for UE-1, the BS may set the UL CCs as {0, 1, 1, 2, 2}, and in this instance, UE-1 may map one resource index to CC-0, and map two resource indices to each of CC-1 and CC-2. As another example, for UE-1, the BS may set the UL CCs as {0, 0, 0, 2, 2} such that UE-1 may map three resource indices to CC-0, map no resource indices to CC-1, and map two resource indices to CC-2.

According to a second exemplary embodiment, resource indices available for assignment to UEs 106 may be pre-assigned to different pairs of DL CCs and UL CCs, which may be reflected in a table known to the BS 102 and UEs. Also according to this second exemplary embodiment, each UE may be assigned to multiple resource indices at one time. Similar to before, the BS may transmit an indication of the assigned resource indices to the respective UEs. In one more particular example, each UE 106 may be assigned to a number of resource indices equal to the number of DL CCs by which the UE may receive a DL transmission that triggers a control signal. Each of the DL CCs may be paired with an UL CC on which the UE may transmit a control signal. And these DL and UL CCs may be paired such that any two or more DL CCs may be paired with the same UL CC (the number of DL CCs in these instances being greater than the number of UL CCs), thereby permitting assignment of each UE to a respective UE-specific UL CC or a respective UE-specific set of UL CCs. In this regard, a number of the resource indices may be used to transmit non-arranged UL control signals, and others of the resource indices may be used to transmit arranged UL control signals. For a pair of corresponding DL and UL CCs (e.g., DL-0 and UL-0), a non-arranged UL control signal may be one transmitted on an UL CC (e.g., UL CC-0) responsive to a DL transmission on the corresponding DL CC (e.g., DL CC-0), and an arranged UL control signal maybe one responsive to a DL transmission on another DL CC (e.g., DL CC-1).

A UE 106, with knowledge of its assigned resource indices and respective assigned pairs of DL and UL CCs, may be configured to identify a resource index for a control signal responsive to a DL transmission on a particular DL CC. The UE may then calculate the corresponding RB location and determine the corresponding code (CS and/or OC) selection based on the resource index, and transmit a control signal in the UL CC paired with the respective DL CC according to the respective RB location and code selection. In this manner, complex calculations may be avoided, and the BS may save overhead by avoiding the need to signal the UE as to the resource index and UL CC by which to transmit a control signal.

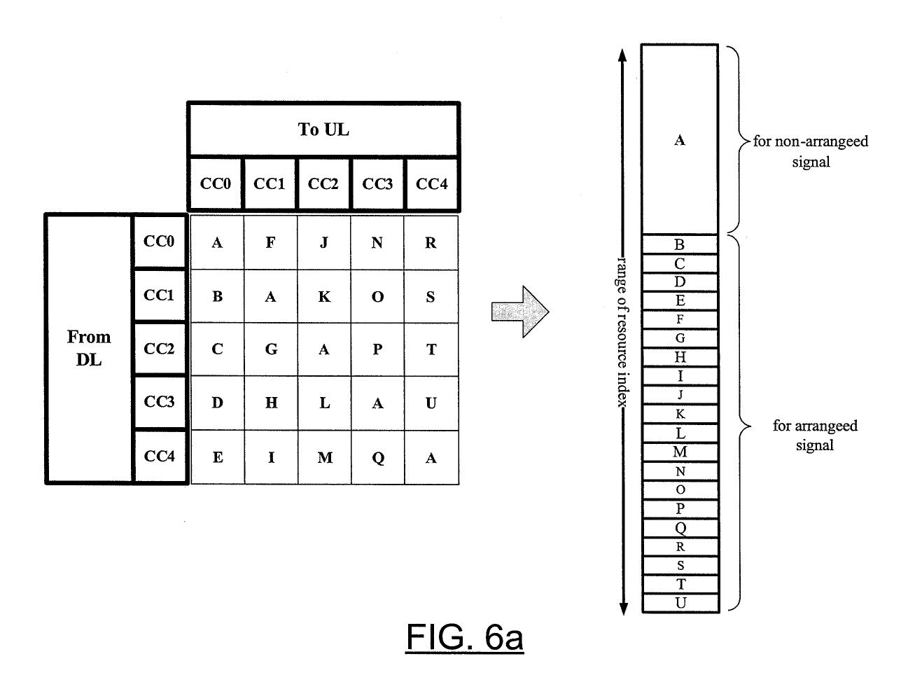

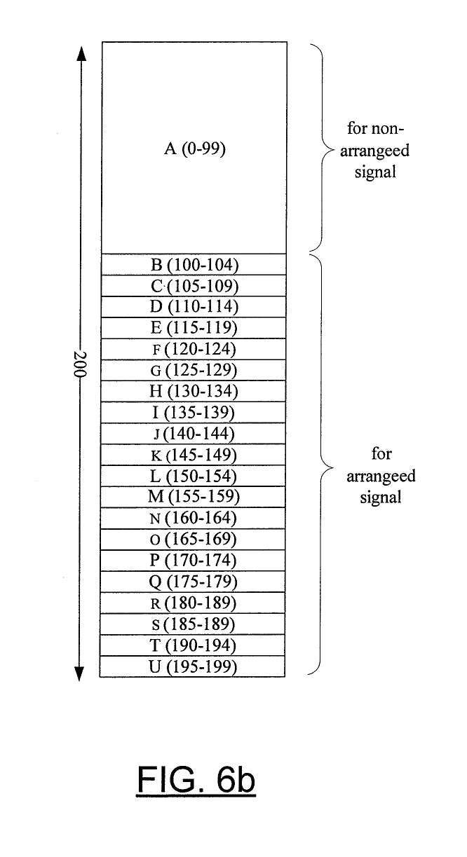

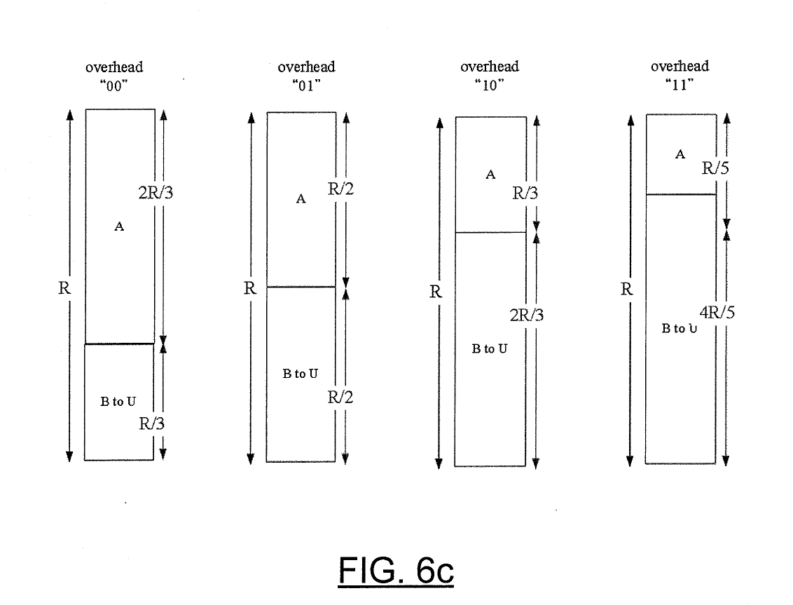

An example of a table by which resource indices may be pre-assigned to different pairs of DL and UL CCs is shown in FIGS. 6a and 6b in the context of five DL CCs and five UL CCs (CC-0, CC-1, CC-2, CC-3, CC-4). Because an arranged control signal in the UL relates to the DL CC (see the rows in the “From DL” block) and paired UL CC (see the columns in “To UL” block), the relationships between the CCs may be expressed in the left table in FIG. 6a, where blocks (A) are for non-arranged UL control signals and the remaining blocks are for arranged control signals. The right, single-column table of FIG. 6a illustrates the available resource indices that may be partitioned into ranges corresponding to blocks A to U, which in turn may be pre-assigned to pairs of DL and UL CCs. In FIG. 6b, it may be assumed that 200 resource indices (from 0 to 199) are available for assignment. The first 100 resource indices may be designated for non-arranged control signals, and the last 100 resource indices may be designed for arranged control signals.

The pre-assignment of blocks of resource indices to pairs of DL and UL CCs may be known to the BS 102 and UEs 106 served by the BS in a cell 104. As shown in FIG. 6c, the BS and UEs may store different tables similar to that shown in FIG. 6b, where each table has different ratio between the number of resource indices designed for non-arranged control signals and those designated for arranged control signals. In this regard, the indication of the assigned resource indices transmitted to the UEs may also indicate a particular table.

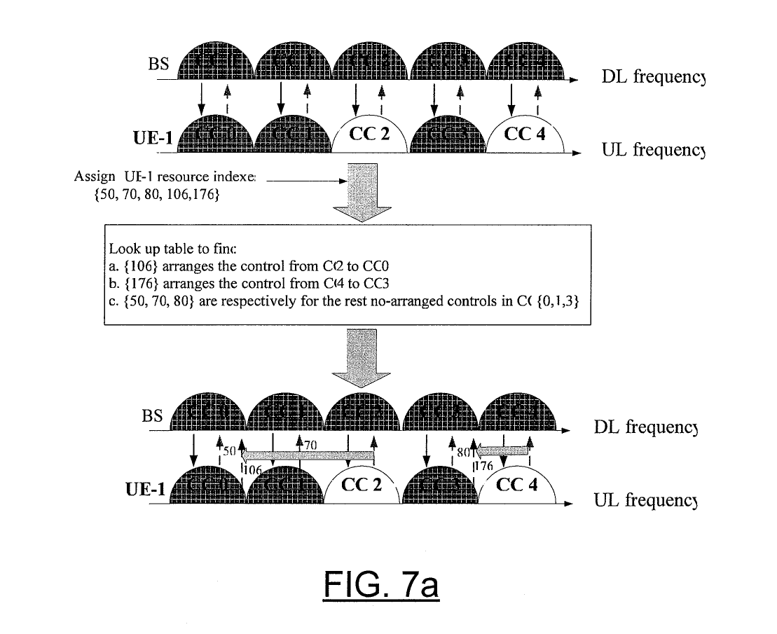

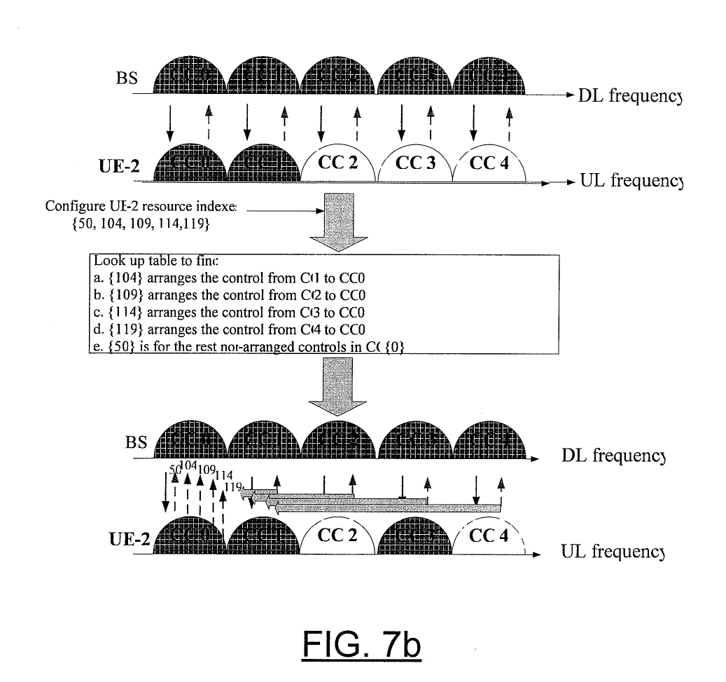

To further illustrate this second exemplary embodiment, and following the example tables of FIGS. 6a and 6b, consider an example scenario in which resource indices n_{PUCCH}ε[0, 99] are for non-arranged UL control signals, while n_{PUCCH}ε[100, 199] are for arranged UL control signals. As shown in FIGS. 7a and 7b for a UE-1 and UE-2, respectively, five DL CCs may be available for DL transmissions from the BS 102 to the UEs 106, and five corresponding UL CCs may be available for transmitting control signals in response to the DL transmissions. Due to UE capability, however, the UEs may be limited to transmitting control signals on a fewer number of UL CCs. As shown, for example, UE-1 may be limited to UL CCs {0, 1, 3}, and UE-2 may be limited to UL CCs {0, 1}.

Now presume that for UE-1, the BS 102 desires to arrange the control signals such that those responsive to DL transmissions in DL CC-2 are transmitted in UL CC-0 (DL CC-2 to UL CC-0), and such that those responsive to DL transmissions on DL CC-4 are transmitted in UL CC-3 (DL CC-4 to UL CC-3). To accomplish this arrangement, the BS may assign n_{PUCCH}=50, 70, 80, 106, 176 to UE-1, as shown in FIG. 7a. Utilizing the tables of FIGS. 6a and 6b, then, the UE-1 may lookup its assigned resource indices to identify the pairs of DL and UL CCs to which the respective indices are pre-assigned. For example, resource indices 50, 70 and 80 may be pre-assigned to pairs of corresponding DL and UL CCs CC-0, CC-1 and CC-3, respectively, for non-arranged control signals. Resource index 106 may be pre-assigned to the pair DL CC-2, UL CC-0; and resource index 176 may be pre-assigned to the pair DL CC-4, UL CC-4. For a DL transmission received in one of the DL CCs, then, UE-1 may identify its paired UL CC and pre-assigned resource index. And from the respective resource index, UE-1 may calculate the corresponding RB location and determine the corresponding code (CS and/or OC) selection, and transmit a control signal in the paired UL CC.

As shown in FIG. 7b, for UE-2, the BS 102 may assign n_{PUCCH}=50, 104, 109, 114, 119. Similar to UE-1, UE-2 may lookup its assigned resource indices to identify the pairs of DL and UL CCs to which the respective indices are pre-assigned. For example, resource index 50 may be pre-assigned to the pair of corresponding DL and UL CC-0 (DL CC-0, UL CC-0) for a non-arranged control signal. Resource index 104 may be pre-assigned to the pair DL CC-1, UL CC-0; resource index 109 may be pre-assigned to the pair DL CC-2, UL CC-0; resource index 114 may be pre-assigned to the pair DL CC-3, UL CC-0; and resource index 119 may be pre-assigned to the pair DL CC-4, UL CC-0. Also similar to UE-1, for a DL transmission received in one of the DL CCs, UE-2 may identify its paired UL CC and pre-assigned resource index, and UE-1 may calculate the corresponding RB location and determine the corresponding code (CS and/or OC) selection, and transmit a control signal in the paired UL CC.

As the example of FIG. 7b illustrates, a UE 106 may be assigned resource indices pre-assigned to pairs of DL and UL CCs such that, in effect, the UE transmits control signals on even fewer UL CCs than those to which the UE is limited. As shown, UE-2 may be limited to UL CC-0 and CC-1, but given its assigned resource indices and their pre-assignments, UE-2 may actually be configured to transmit all of its control signals in UL CC-0. This may permit further power savings.

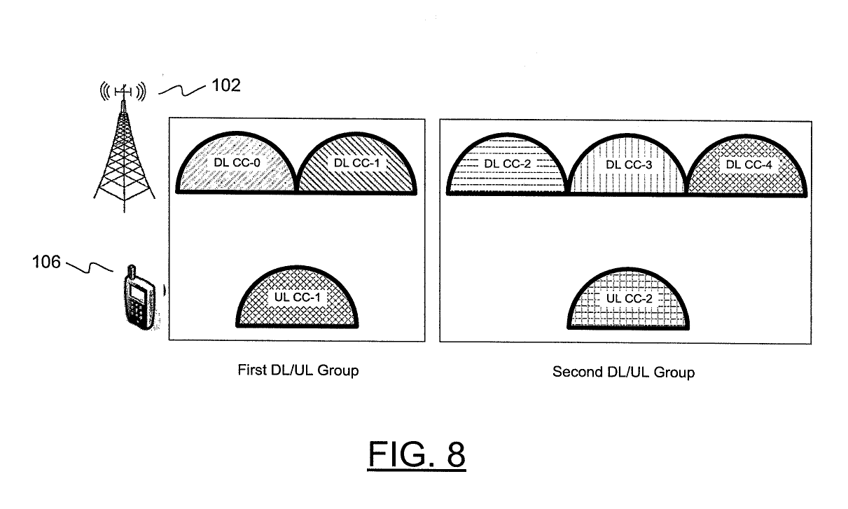

As shown in FIG. 8, according to a third exemplary embodiment, the DL and UL CCs may be organized in UE-specific or cell-specific groups each of which includes one or more DL CCs and one or more UL CCs. Also according to the third exemplary embodiment, resource indices available for assignment to UEs 106 may be pre-assigned to different pairs of DL CCs and UL CCs in each group, where the same resource indices may be assigned to multiple groups. The examples herein illustrate instances in which groups of DL/UL CCs include multiple DL CCs and a single UL CC. It should be understood that the groups may include one or more DL CCs and more than one UL CC—although given instances in which the DL CCs outnumber the UL CCs, one or more groups may include more DL CCs than UL CCs. It may be the case, however, that within any one group, a resource index may be assigned to a single pair of DL and UL CCs.

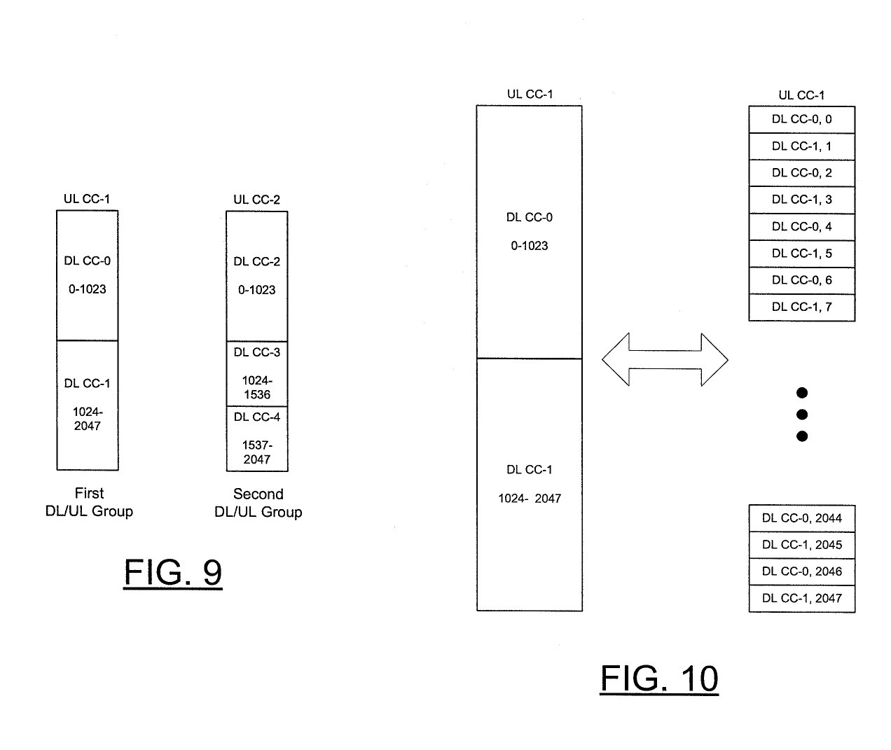

In each group of DL/UL CCs, each pair of DL CC and UL CC may have multiple resource indices assigned to it. The assignment of resource indices in a group may be localized or distributed. That is, as shown in FIG. 9 for two groups, the assignment of resource indices may be localized such that ranges of consecutive resource indices are assigned to respective pairs of DL and UL CCs. Alternatively, as shown in FIG. 10 for one group, the assignment of resource indices may be distributed such that the resource indices are sequentially assigned to respective pairs of DL and UL CCs in a cyclic manner.

Each UE 106 may be assigned to one or more groups of DL/UL CCs and, similar to the second exemplary embodiment, may be assigned to multiple resource indices. An indication of the assigned group and resource indices may be transmitted to the respective UEs. A UE, with knowledge of its assigned resource indices and groups of DL/UL CCs, may be configured to identify a resource index for a control signal responsive to a DL transmission on a particular DL CC. The UE may then calculate the corresponding RB location and determine the corresponding code (CS and/or OC) selection based on the resource index, and transmit a control signal in the UL CC paired with the respective DL CC according to the respective RB location and code selection.

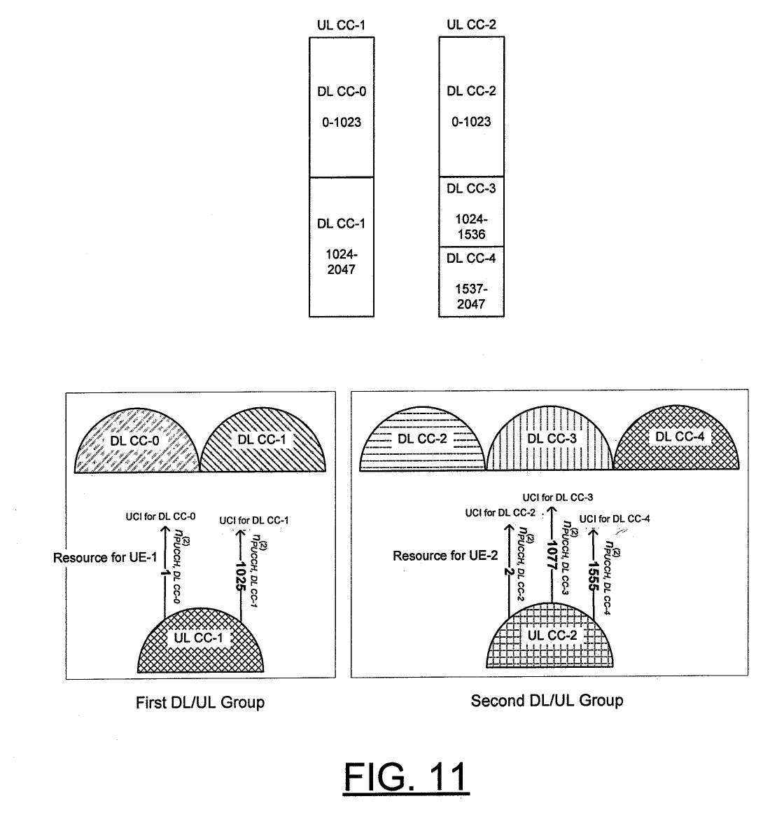

Reference is now made to FIG. 11, which furthers the example of FIG. 8 according to the third exemplary embodiment. As shown, the DL and UL CCs may be organized in two groups, the first of which includes two DL CCs (CC-0 and CC-1) and one UL CC (CC-1), and the second of which includes three DL CCs (CC-2, CC-3 and CC-4) and one UL CC (CC-2). Consider for this example the case of two UEs 106, UE-1 and UE-2. UE-1 may be assigned to the first group, and may be assigned resource indices n_{PUCCH}=1, 1025; and UE-2 may be assigned to the second group, and may be assigned resource indices n_{PUCCH}=2, 1077, 1555.

For an UL transmission opportunity, FIG. 11 illustrates that UE-1 may transmit an UL control signal (shown as UL control information—UCI) in UL CC-1 in response to a DL transmission from DL CC-0 and/or CC-1; and UE-2 may transmit an UL control signal from UL CC-2 in response to a DL transmission in DL CC-2, CC-3 and/or CC-4.

As also shown in FIG. 11, when UE-1 transmits an UL control signal in UL CC-1 utilizing resource index n_{PUCCH, DL CC-0}⁽²⁾=1, the UL control signal may belong to paired DL CC-0. When UE-1 transmits an UL control signal in UL CC-1 utilizing resource index n_{PUCCH, DL CC-1}⁽²⁾=1025, the UL control signal may belong to paired DL CC-1. In the preceding and throughout, the superscript in the resource index notation reflects a particular PUCCH format in accordance with LTE, although it should be understood that exemplary embodiments of the present invention may be equally applicable in contexts other than LTE.

Similarly, when UE-2 transmits an UL control signal in UL CC-2 utilizing resource index n_{PUCCH, DL CC-2}⁽²⁾=2, the UL control signal may belong to paired DL CC-2. When UE-2 transmits an UL control signal in UL CC-2 utilizing n_{PUCCH, DL CC-3}⁽²⁾=1077, the UL control signal may belong to paired DL CC-3. And when UE-2 transmits an UL control signal in UL CC-2 utilizing resource index n_{PUCCH, DL CC-4}⁽²⁾=1555, the UL control signal may belong to DL CC-4.

The various exemplary embodiments described above may apply to any number of different UL control signals, such as CQI with or without ACK, NACK control signals. In other instances, the above exemplary embodiments may more particularly include transmission of ACK/NACK control signals in accordance with various techniques permitting transmission of multiple such signals. Examples of these techniques, referred to as “ACK/NACK multiplexing” and “ACK/NACK bundling” are described in greater detail below.

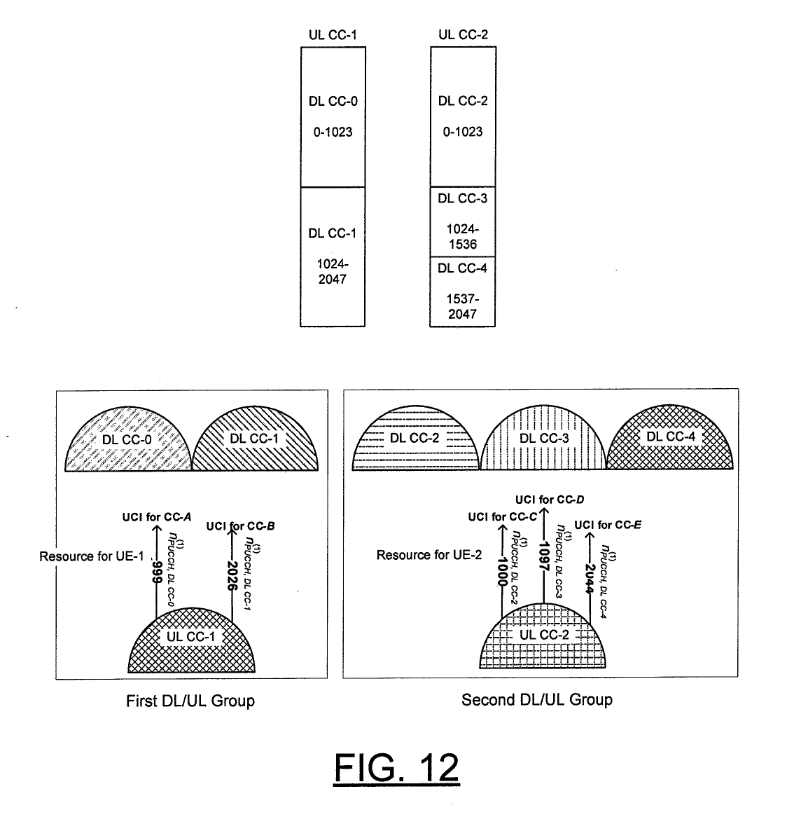

According to one example ACK/NACK multiplexing technique, a UE 106 may be configured to transmit multiple ACKs (e.g., HARQ-ACKs) in a single UL CC. As shown in FIG. 12, when UE-1 receives a DL transmission from both DL CC-0 and CC-1, UE-1 may transmit a corresponding ACK/NACK control signal in UL CC-1 in the corresponding UL transmission time. Table 1 below illustrates a detail signal presentation technique whereby a control signal may include two bits ACK/NACK in the UL. For example, when {A/N_{DL CC-0}, A/N_{DL CC-1}}={ACK, NACK}, UE-1 may transmit [b(0), b(1)]=[0, 1] in UL CC-1 and use the corresponding resource index n_{PUCCH, DL CC-0}⁽²⁾=999 to generate the control signal.

TABLE 1

| | | |
|---|---|---|
| ACK (DL CC-0), ACK (DL CC-1) | n_{PUCCH}⁽¹⁾ | b(0), b(1) |
| ACK, ACK | n_{PUCCH, DL CC-1}⁽¹⁾ | 1, 1 |
| ACK, NACK/DTX | n_{PUCCH, DL CC-0}⁽¹⁾ | 0, 1 |
| NACK/DTX, ACK | n_{PUCCH, DL CC-1}⁽¹⁾ | 0, 0 |
| NACK/DTX, NACK | n_{PUCCH, DL CC-1}⁽¹⁾ | 1, 0 |
| NACK, DTX | n_{PUCCH, DL CC-0}⁽¹⁾ | 1, 0 |
| DTX, DTX | N/A | N/A |

When UE-2 receives a DL transmission on DL CC-2, CC-3 and CC-4, UE-2 may transmit a corresponding ACK/NACK control signal in UL CC-2 in the corresponding UL transmission time. Table 2 below illustrates a detail signal presentation technique whereby the control signal may include three bits ACK/NACK in the UL. For example, when {A/N_{DL CC-2}, A/N_{DL CC-3}, A/N_{DL CC-4}}={ACK, NACK, ACK}, UE-2 may transmit [b(0), b(1)]=[1, 1] in UL CC-2 and use the corresponding resource n_{PUCCH, DL CC-2}⁽²⁾=1000 to generate the control signal.

TABLE 2

| | | |
|---|---|---|
| ACK (DL CC-2), ACK (DL CC-3), | n_{PUCCH}⁽¹⁾ | b(0), b(1) |
| ACK (DL CC-4) | | |
| ACK, ACK, ACK | n_{PUCCH, DL CC-4}⁽¹⁾ | 1, 1 |
| ACK, ACK, NACK/DTX | n_{PUCCH, DL CC-3}⁽¹⁾ | 1, 1 |
| ACK, NACK/DTX, ACK | n_{PUCCH, DL CC-2}⁽¹⁾ | 1, 1 |
| ACK, NACK/DTX, NACK/DTX | n_{PUCCH, DL CC-2}⁽¹⁾ | 0, 1 |
| NACK/DTX, ACK, ACK | n_{PUCCH, DL CC-4}⁽¹⁾ | 1, 0 |
| NACK/DTX, ACK, NACK/DTX | n_{PUCCH, DL CC-3}⁽¹⁾ | 0, 0 |
| NACK/DTX, NACK/DTX, ACK | n_{PUCCH, DL CC-4}⁽¹⁾ | 0, 0 |
| DTX, DTX, NACK | n_{PUCCH, DL CC-4}⁽¹⁾ | 0, 1 |
| DTX, NACK, NACK/DTX | n_{PUCCH, DL CC-3}⁽¹⁾ | 1, 0 |
| NACK, NACK/DTX, NACK/DTX | n_{PUCCH, DL CC-2}⁽¹⁾ | 1, 0 |
| DTX, DTX, DTX | N/A | N/A |

Similar to the ACK/NACK multiplexing technique, according to one example ACK/NACK bundling technique, a UE 106 may be configured to transmit multiple ACKs (e.g., HARQ-ACKs) on single UL CC. According to the bundling technique, however, multiple ACK/ACK control signals may be bundled by Boolean ‘AND’ operators to generate one or two bit bundled ACK/NACK.

As shown in FIG. 12, when UE-1 receives a DL transmission from both DL CC-0 and CC-1, UE-1 may transmit a corresponding ACK/NACK control signal in UL CC-1 in the corresponding UL transmission time. The process followed by each of UE-1 and UE-2 for transmitting the ACK/NACK control signals may depend on whether the DL transmission includes one or more codewords for each DL CC.

When the DL transmission includes one codeword for each DL CC, the UE may generate a one bit ACK/NACK for DL CC-0 and CC-1, b(0)=[(A/N_{DL CC-0}) AND (A/N_{DL CC-1})]. In this regard, A/N_{DL CC-0} may refer to an ACK/NACK responsive to the DL transmission on DL CC-0; and A/N_{DL CC-1} may refer to an ACK/NACK responsive to the DL transmission on DL CC-1. In this example, there may be two resource indices {n_{PUCCH, DL CC-0}⁽¹⁾,n_{PUCCH, DL CC-1}⁽¹⁾}={999, 2026} that may be used for transmitting the ACK on the UL. UE-1 may select one of the resource indices based on a pre-defined rule, and transmit the bundled ACK. For example, UE-1 may select n_{PUCCH, DL CC-0}⁽¹⁾=999.

When the DL transmission includes two or more codewords for each DL CC, UE-1 may generate a two bit ACK/NACK for DL CC-0 and CC-1, and may perform ACK/NACK bundling per codeword across two DL CCs. For example, A/N_{DL CC-0(0)} may refer to an ACK/NACK responsive to the first codeword on DL CC-0; A/N_{DL CC-0(1)} may refer to an ACK/NACK responsive to the second codeword on DL CC-0; A/N_{DL CC-1(0)} may refer to an ACK/NACK responsive to the first codeword on DL CC-1; and A/N_{DL CC-1(1)} may refer to an ACK/NACK responsive to the second codeword on DL CC-1. Hence, two bit ACK/NACK bundling information [b(0), b(1)] may be obtained by,
b(0)=[(A/N_{DL CC-0(0)}) AND (A/N_{DL CC-1(0)})],
b(1)=[(A/N_{DL CC-0(1)}) AND (A/N_{DL CC-1(1)})]
   In this example, there may be two resource indices {n_{PUCCH, DL CC-0}⁽¹⁾,n_{PUCCH, DL CC-1}⁽¹⁾}={999, 2026} may be utilized for transmitting the ACK on the UL. UE-1 may select one of the resource indices based on a pre-defined rule, and may transmit the ACK according to it. For example, UE-1 may select n_{PUCCH, DL CC-0}⁽¹⁾=999.

Similar to UE-1, when UE-2 receives a DL transmission on DL CC-2, CC-3 and CC-4, UE-2 may transmit a corresponding ACK/NACK control signal in UL CC-2 in corresponding UL transmission time. When the DL transmission includes a single codeword for each DL CC, UE-2 may generate a one bit ACK/NACK for DL CC-2, CC-3 and CC-4, b(0)=[(A/N_{DL CC-2}) AND (A/N_{DL CC-3}) AND (A/N_{DL CC-4})]. In this regard, A/N_{DL CC-2} may refer to an ACK/NACK responsive to the DL transmission on DL CC-2; A/N_{DL CC-3} may refer to an ACK/NACK responsive to the DL transmission on DL CC-3; and A/N_{DL CC-4} may refer to an ACK/NACK responsive to the DL transmission on DL CC-4. In this example, there may be three resource indices {n_{PUCCH, DL CC-2}⁽¹⁾,n_{PUCCH, DL CC-3}⁽¹⁾,n_{PUCCH, DL CC-4}⁽¹⁾}={1000, 1097, 2044} may be used for transmitting the ACK. UE-2 may select a resource index based on a pre-defined rule, and may transmit the bundled ACK according to it. For example, UE-2 may select n_{PUCCH, DL CC-2}⁽¹⁾1000.

When the DL transmission includes two or more codewords for each DL CC, UE-2 may generate a two bit ACK/NACK for DL CC-2, CC-3 and CC-4, and ACK/NACK bundling may be performed per codeword across three DL CCs. For example, A/N_{DL CC-2(0)} may refer to an ACK/NACK for the first codeword transmitted on DL CC-2; A/N_{DL CC-2(1)} may refer to an ACK/NACK for the second codeword on DL CC-2; A/N_{DL CC-3(0)} may refer to an ACK/NACK for the first codeword on DL CC-3; A/N_{DL CC-3(1)} may refer to an ACK/NACK for the second codeword on DL CC-3; A/N_{DL CC-4(0)} may refer to an ACK/NACK for the first codeword on DL CC-4; and A/N_{DL CC-2(1)} may refer to an ACK/NACK for the second codeword on DL CC-4. Hence, two bit ACK/NACK bundling information [b(0), b(1)] may be obtained by,
b(0)=[(A/N_{DL CC-2(0)}) AND (A/N_{DL CC-3(0)}) AND (A/N_{DL CC-4(0)})],
b(1)=[(A/N_{DL CC-2(1)}) AND (A/N_{DL CC-3(1)}) AND (A/N_{DL CC-4(1)})]
   In this example, there may be three resource indices {n_{PUCCH, DL CC-2}⁽¹⁾,n_{PUCCH, DL CC-3}⁽¹⁾,n_{PUCCH, DL CC-4}⁽¹⁾}={1000, 1097, 2044} that may be utilized for transmitting the ACK on the UL. UE-2 may select a resource index based on a pre-defined rule, and may transmit the ACK according to it. For example, UE-2 may select n_{PUCCH, DL CC-2}⁽¹⁾=1000.

According to exemplary embodiments of the present invention, a UE 106 may be assigned or may otherwise derive a number of resource indices for use in transmitting UL control signals, and in various instances may be further assigned to a group of DL/UL CCs. These resource indices and/or group of DL/UL CCs may be static over time or, in various instances, may vary over time such as in accordance with a hopping function—which in addition to an initially-assigned or derived resource index and/or DL/UL CC group and time, may also include as a variable the range of resource indices and/or DL/UL CC groups available to a particular UE. This time hopping of resource indices and/or DL/UL CC groups may permit randomization in the UL control channel (PUCCH).

According to one aspect of the present invention, all or a portion of the BS 102 and/or UE 106 of exemplary embodiments of the present invention, generally operate under control of a computer program. The computer program for performing the methods of exemplary embodiments of the present invention may include one or more computer-readable program code portions, such as a series of computer instructions, embodied or otherwise stored in a computer-readable storage medium, such as the non-volatile storage medium.

FIGS. 4, 7a, 7b, 11 and 12 are block diagrams reflecting methods, systems and computer programs according to exemplary embodiments of the present invention. It will be understood that each block or step of the block diagrams, and combinations of blocks in the block diagrams, may be implemented by various means, such as hardware, firmware, and/or software including one or more computer program instructions. As will be appreciated, any such computer program instructions may be loaded onto a computer or other programmable apparatus to produce a machine, such that the instructions which execute on the computer or other programmable apparatus (e.g., hardware) create means for implementing the functions specified in the block(s) or step(s) of the block diagrams. These computer program instructions may also be stored in a computer-readable memory that may direct a computer or other programmable apparatus to function in a particular manner, such that the instructions stored in the computer-readable memory produce an article of manufacture including instruction means which implement the function specified in the block(s) or step(s) of the block diagrams. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the block(s) or step(s) of the block diagrams.

Accordingly, blocks or steps of the block diagrams support combinations of means for performing the specified functions, combinations of steps for performing the specified functions and program instruction means for performing the specified functions. It will also be understood that one or more blocks or steps of the block diagrams, and combinations of blocks or steps in the block diagrams, may be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. It should therefore be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus for allocating uplink resources in a system in which a plurality of downlink component carrier bands are aggregated and a plurality of uplink component carrier bands are aggregated, and in which the apparatus is configured to transmit an uplink control signal in one of the uplink component carrier bands in response to a downlink transmission in one of the downlink component carrier bands, the apparatus comprising a processor configured to perform or cause the apparatus to perform the following:
receiving an assignment or an indication of an assignment of a resource index to the apparatus;
deriving one or more additional resource indices for the apparatus as a function of the assigned resource index, each of the assigned resource index and one or more additional resource indices specifying an allocation of uplink resources for the apparatus to transmit uplink control signals; and
mapping the assigned and one or more additional resource indices to a subset of uplink component carrier bands, the subset including one or more of the plurality of uplink component carrier bands,
wherein for each uplink component carrier band in the subset, mapping the assigned and one or more additional resource indices to the uplink component carrier band enables the apparatus to transmit one or more uplink control signals in the uplink component carrier band in accordance with the allocation of uplink resources specified by the respective assigned and one or more additional resource indices.

2. The apparatus of claim 1, wherein mapping the assigned and one or more additional resource indices comprises sequentially mapping the assigned and one or more additional resource indices to the uplink component carrier bands of the subset, and
wherein when the number of assigned and one or more additional resource indices exceeds the number of uplink component carrier bands in the subset, the mapping includes employing a module operation to map remaining resource indices after a resource index is mapped to each uplink component carrier band of the subset.

3. The apparatus of claim 1, wherein mapping the assigned and one or more additional resource indices comprises mapping the assigned and one or more additional resource indices to the uplink component carrier bands of the subset according to a setting of a number of uplink control signals the apparatus is permitted to transmit in an uplink control carrier band of the subset, the setting being such that a different number of resource indices are mapped to at least one component carrier band than are mapped to at least one other component carrier band of the subset.

4. The apparatus of claim 1, wherein the processor is further configured to perform or cause the apparatus to perform the following:
preparing for transmission a single uplink control signal in one of the uplink component carrier bands in response to downlink transmissions in two or more of the downlink component carrier bands, the single uplink control signal separately reflecting an acknowledgement or negative acknowledgement, or discontinuous transmission, for each of the downlink transmissions.

5. The apparatus of claim 1, wherein one or more of the assigned resource index or one or more of the additional resource indices vary over time in accordance with a hopping function.

6. A method of allocating uplink resources in a system in which a plurality of downlink component carrier bands are aggregated and a plurality of uplink component carrier bands are aggregated, and in which user equipment is configured to transmit an uplink control signal in one of the uplink component carrier bands in response to a downlink transmission in one of the downlink component carrier bands, the method comprising:
receiving an assignment or an indication of an assignment of a resource index to the user equipment;
deriving one or more additional resource indices for the user equipment as a function of the assigned resource index, each of the assigned resource index and one or more additional resource indices specifying an allocation of uplink resources for the user equipment to transmit uplink control signals; and
mapping the assigned and one or more additional resource indices to a subset of uplink component carrier bands, the subset including one or more of the plurality of uplink component carrier bands,
wherein for each uplink component carrier band in the subset, mapping the assigned and one or more additional resource indices to the uplink component carrier band enables the user equipment to transmit one or more uplink control signals in the uplink component carrier band in accordance with the allocation of uplink resources specified by the respective assigned and one or more additional resource indices, and
wherein one or more of receiving an assignment, deriving one or more additional resources or mapping the assigned and one or more additional resources are performed by a processor configured to one or more of receive an assignment, derive one or more additional resources or map the assigned and one or more additional resources.

7. The method of claim 6, wherein mapping the assigned and one or more additional resource indices comprises sequentially mapping the assigned and one or more additional resource indices to the uplink component carrier bands of the subset, and
wherein when the number of assigned and one or more additional resource indices exceeds the number of uplink component carrier bands in the subset, the mapping includes employing a module operation to map remaining resource indices after a resource index is mapped to each uplink component carrier band of the subset.

8. The method of claim 6, wherein mapping the assigned and one or more additional resource indices comprises mapping the assigned and one or more additional resource indices to the uplink component carrier bands of the subset according to a setting of a number of uplink control signals the user equipment is permitted to transmit in an uplink control carrier band of the subset, the setting being such that a different number of resource indices are mapped to at least one component carrier band than are mapped to at least one other component carrier band of the subset.

9. The method of claim 6 further comprising:
preparing for transmission a single uplink control signal in one of the uplink component carrier bands in response to downlink transmissions in two or more of the downlink component carrier bands, the single uplink control signal separately reflecting an acknowledgement or negative acknowledgement, or discontinuous transmission, for each of the downlink transmissions.

10. The method of claim 6, wherein one or more of the assigned resource index or one or more of the additional resource indices vary over time in accordance with a hopping function.

11. An apparatus for allocating uplink resources in a system in which a plurality of downlink component carrier bands are aggregated and a plurality of uplink component carrier bands are aggregated, and in which the apparatus is configured to transmit an uplink control signal in one of the uplink component carrier bands in response to a downlink transmission in one of the downlink component carrier bands, the apparatus comprising a processor configured to perform or cause the apparatus to perform the following:
receiving an assignment or an indication of an assignment of a plurality of resource indices to the apparatus, the assigned resource indices specifying respective allocations of uplink resources for the apparatus to transmit uplink control signals, the assigned resource indices being pre-assigned to respective pairs of component carrier bands each of which includes a downlink component carrier band and an uplink component carrier band;
identifying a resource index from the assigned resource indices, the respective resource index being identified as being pre-assigned to a particular pair of component carrier bands including a downlink component carrier band in which a downlink transmission is received; and
preparing for transmission an uplink control signal in accordance with the allocation of uplink resources specified by the identified resource index, the uplink control signal being prepared for transmission in the uplink component carrier of the particular pair of component carrier bands.

12. The apparatus of claim 11, wherein the assigned resource indices are from a greater plurality of available resource indices pre-assigned to respective pairs of component carrier bands, the pre-assignment of available resource indices to respective pairs of component carrier bands being reflected in a table stored by the user equipment, and
wherein identifying a resource index comprises identifying a resource index from the table, and
wherein preparing an uplink control signal includes identifying from the table the uplink component carrier of the particular pair of component carrier bands.

13. The apparatus of claim 11, wherein preparing an uplink control signal comprises preparing for transmission a single uplink control signal in response to downlink transmissions in two or more of the downlink component carrier bands, the single uplink control signal separately reflecting an acknowledgement or negative acknowledgement, or discontinuous transmission, for each of the downlink transmissions.

14. The apparatus of claim 11, wherein one or more of the assigned resource indices vary over time in accordance with a hopping function.

15. The apparatus of claim 11, wherein the plurality of downlink component carrier bands and uplink component carrier bands are organized in groups each of which includes one or more downlink component carrier bands and one or more uplink component carrier bands,
wherein the assigned resource indices are from a greater plurality of available resource indices each of which is pre-assigned to each of one or more of the groups, wherein for each group, the respective pre-assigned available resource indices are further pre-assigned to respective pairs of the component carrier bands of the group,
wherein the processor is further configured to perform or cause the apparatus to perform receiving an assignment or an indication of an assignment of one of the groups to the apparatus, and
wherein identifying a resource index comprises identifying a resource index further from the assigned group.

16. The apparatus of claim 15, wherein for each group, the respective pre-assigned resource indices are further pre-assigned to respective pairs of the component carrier bands in a localized manner such that ranges of consecutive ones of the respective pre-assigned resource indices are assigned to respective pairs of the component carrier bands, or in a distributed manner such that the respective pre-assigned resource indices are sequentially assigned to respective pairs of the component carrier bands.

17. The apparatus of claim 15, wherein preparing an uplink control signal comprises preparing for transmission a single uplink control signal in response to downlink transmissions in two or more of the downlink component carrier bands, the single uplink control signal separately reflecting an acknowledgement or negative acknowledgement, or discontinuous transmission, for each of the downlink transmissions.

18. The apparatus of claim 15, wherein one or more of the assigned resource indices or assigned group vary over time in accordance with a hopping function.

19. A method of allocating uplink resources in a system in which a plurality of downlink component carrier bands are aggregated and a plurality of uplink component carrier bands are aggregated, and in which user equipment is configured to transmit an uplink control signal in one of the uplink component carrier bands in response to a downlink transmission in one of the downlink component carrier bands, the method comprising:
receiving an assignment or an indication of an assignment of a plurality of resource indices to the user equipment, the assigned resource indices specifying respective allocations of uplink resources for the user equipment to transmit uplink control signals, the assigned resource indices being pre-assigned to respective pairs of component carrier bands each of which includes a downlink component carrier band and an uplink component carrier band;
identifying a resource index from the assigned resource indices, the respective resource index being identified as being pre-assigned to a particular pair of component carrier bands including a downlink component carrier band in which a downlink transmission is received; and
preparing for transmission an uplink control signal in accordance with the allocation of uplink resources specified by the identified resource index, the uplink control signal being prepared for transmission in the uplink component carrier of the particular pair of component carrier bands,
wherein one or more of receiving an assignment, identifying a resource index or preparing an uplink control signal for transmission are performed by a processor configured to one or more of receive an assignment, identify a resource index or prepare an uplink control signal for transmission.

20. The method of claim 19, wherein the assigned resource indices are from a greater plurality of available resource indices pre-assigned to respective pairs of component carrier bands, the pre-assignment of available resource indices to respective pairs of component carrier bands being reflected in a table stored by the user equipment, and
wherein identifying a resource index comprises identifying a resource index from the table, and
wherein preparing an uplink control signal includes identifying from the table the uplink component carrier of the particular pair of component carrier bands.

21. The method of claim 19, wherein preparing an uplink control signal comprises preparing for transmission a single uplink control signal in response to downlink transmissions in two or more of the downlink component carrier bands, the single uplink control signal separately reflecting an acknowledgement or negative acknowledgement, or discontinuous transmission, for each of the downlink transmissions.

22. The method of claim 19, wherein one or more of the assigned resource indices vary over time in accordance with a hopping function.

23. The method of claim 19, wherein the plurality of downlink component carrier bands and uplink component carrier bands are organized in groups each of which includes one or more downlink component carrier bands and one or more uplink component carrier bands,
wherein the assigned resource indices are from a greater plurality of available resource indices each of which is pre-assigned to each of one or more of the groups, wherein for each group, the respective pre-assigned available resource indices are further pre-assigned to respective pairs of the component carrier bands of the group,
wherein the method further comprises receiving an assignment or an indication of an assignment of one of the groups to the user equipment, and
wherein identifying a resource index comprises identifying a resource index further from the assigned group.

24. The method of claim 23, wherein for each group, the respective pre-assigned resource indices are further pre-assigned to respective pairs of the component carrier bands in a localized manner such that ranges of consecutive ones of the respective pre-assigned resource indices are assigned to respective pairs of the component carrier bands, or in a distributed manner such that the respective pre-assigned resource indices are sequentially assigned to respective pairs of the component carrier bands.

25. The method of claim 23, wherein preparing an uplink control signal comprises preparing for transmission a single uplink control signal in response to downlink transmissions in two or more of the downlink component carrier bands, the single uplink control signal separately reflecting an acknowledgement or negative acknowledgement, or discontinuous transmission, for each of the downlink transmissions.

26. The method of claim 23, wherein one or more of the assigned resource indices or assigned group vary over time in accordance with a hopping function.
